(19) United States
(12) Patent Application Publication
(10) Pub. No.: US 2016/0208045 A1
(43) Pub. Date: Jul. 21, 2016

(54) POLYMERIC MATERIAL

(71) Applicant: VICTREX MANUFACTURING LIMITED, Thornton Cleveleys Lancashire (GB)

(72) Inventors: Nigel Philip SLATER, Poulton-Le-Fylde, Lancashire (GB); Glynn HARRINGTON, Chorley, Lancashire (GB); Richard Luke AINSWORTH, Preston, Lancashire (GB)

(73) Assignee: VICTREX MANUFACTURING LIMITED, Thornton Cleveleys, Lancashire (GB)

(21) Appl. No.: 14/917,029

(22) PCT Filed: Sep. 26, 2014
(86) PCT No.: PCT/GB2014/052818

§ 371 Date: Mar. 7, 2016

(30) Foreign Application Priority Data
Sep. 27, 2013 (GB) 1317183.0

(51) Int. Cl. C08G 65/38

(52) U.S. Cl. CPC C08G 65/38

(57) ABSTRACT

Polyetheretherketone (PEEK) may be prepared by polycondensation of a single monomer (4-fluoro-4′-(4-hydroxyphenoxy) benzophenone) in diphenylsulphone (DPS) solvent and in the presence of sodium carbonate and potassium carbonate. The process can be used to produce high quality, relatively light coloured polymers having a lower Tm than those produced using a standard PEEK process.

The invention relates to a process for making a polymeric material and a polymeric material per se. Particularly, although not exclusively, the invention relates to a process for making polyetheretherketone (PEEK) and a novel PEEK per se.

PEEK polymers are known to have a range of outstanding properties, including excellent heat resistance, chemical resistance, dimensional stability and mechanical properties. They are utilised in a wide range of demanding applications, including, amongst others, aerospace, automotive, electronics, deep sea oil and gas, and nuclear industries, as well as being approved for a wide range of medical uses.

A number of companies currently manufacture PEEK polymers (including Evonik Industries, Solvay and Applicant), and currently all of these manufacturers rely on a nucleophilic reaction process (as disclosed generally in European Patent Publication EP1879) whereby 1,4-dihydroxybenzene (HQ) is reacted with 4,4′-difluorobenzophenone (BDF) at elevated temperature in the presence of a suitable high boiling solvent (typically diphenylsulfone or sulfolane) and typically in the presence of a carbonate base in order to promote the polymerisation reaction.

Alternative, electrophilic routes, to PEEK polymers are also possible (see for example European patents EP1263836B and EP1170318B) although such routes are believed not to be used to produce PEEK commercially.

There are a number of significant problems with the standard industrial nucleophilic process to PEEK polymers which will be well known to those skilled in the art and include:
a) The process is typically run batch-wise, with all reagents present in the reactor at the start of reaction.
b) In order to control molecular weight, precise control of the ratio of 1,4-dihydroxybenzene and 4,4′-difluorobenzophenone monomers is required. Whilst this is straightforward on a small scale, on an industrial scale this precise control can be a problem, meaning that control of polymer molecular weight can be difficult.
c) Both monomers need to be of exceptionally high purity in order to produce high quality PEEK polymer. Very small changes in the purity of either monomer can have a dramatic and undesirable effect on the resultant polymer properties, as well as making the polymerisation reaction difficult to control.
d) Both monomers are susceptible to being lost from the reaction mixture by sublimation at elevated temperatures, meaning that precise control of monomer ratio can be difficult.
e) Two moles of base (typically carbonate) are required to generate every mole of PEEK polymer repeat unit.
f) The nucleophilic process generates two moles of CO₂ gas for every polymer repeat unit which is generated. If not controlled, this gas evolution can represent a significant process safety hazard.
g) Control of gas evolution rate results in extended polymerisation times.
h) The risk of the reaction mixture foaming means that the polymerisation vessels have to be run with a significant headspace present—thus reducing plant efficiency.
i) As molecular weight increases, the oligomers which are formed have the potential to crystallise in the reactor—resulting in poor heat transfer and, consequently, extended reaction times. Because of this effect, there is essentially a limit on how concentrated the polymerisation reaction can be run.
j) The 1,4-dihydroxybenzene monomer which is used is known to have significant health hazards associated with it (category 3 mutagen).
k) The 1,4-dihydroxybenzene monomer is very sensitive to reaction with atmospheric oxygen, meaning that the polymerisation process has to be rigorously inerted with nitrogen.
l) Every mole of polymer repeat unit which is generated also results in the generation of two moles of fluoride salt bi-product. This has to be removed in a subsequent process, generating significant quantities of effluent.

It is an object of the preferred embodiments of the present invention to address at least some of the aforementioned problems.

In addition, commercially available PEEK has a Tg of 143° C. and a Tm of about 340° C.

For many applications, however, it is desirable to maintain relatively high Tg but lower the Tm so as to facilitate melt processing. It is an object of preferred embodiments of the invention to address this problem.

Furthermore, it is desirable for PEEK polymers produced to be as light in colour as possible, since darker polymers may be perceived to be of lower quality (e.g. as being relatively impure). Lighter coloured PEEK is generally preferred for applications where the aesthetics of the article are important. It is an object of preferred embodiments to address this problem.

According to a first aspect of the invention, there is provided a process for producing a polymeric material having a repeat unit of formula

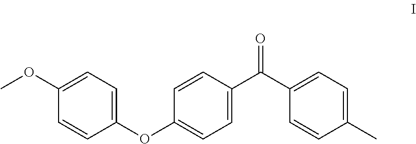

the process comprising polycondensing a monomer of structure

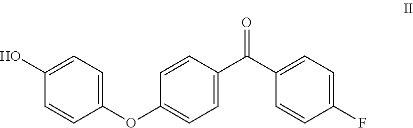 [SMILES: O=C(c1ccc(F)cc1)c1ccc(Oc2ccc(O)cc2)cc1]

Thus, in the process, monomers of structure II are polycondensed with one another to produce the polymeric material of formula I.

Said process is preferably carried out in the presence of one or more carbonates. The process is preferably carried out in the presence of alkali metal carbonate. Said process is preferably carried out in the presence of one or more carbonates which preferably include sodium carbonate, which may, optionally, be in combination with potassium carbonate.

The total mol % of carbonates used in the process (i.e. the total number of moles of carbonates used in the process divided by the total number of moles of hydroxy monomer(s) used (especially said monomer of structure II), expressed as a percentage) is suitably at least 100 mol %.

The total mol % of carbonates may be greater than 100 mol %. It may be less than 105 mol %.

The mol % of sodium carbonate used in the process (i.e. the moles of sodium carbonate used in the process divided by the moles of said monomer of structure II) may be at least 90 mol %, preferably at least 92 mol %, more preferably at least 95 mol %.

The total mol % of sodium carbonate and potassium carbonate used in the process (i.e. the sum of the moles of sodium carbonate and potassium carbonate used in the process divided by the moles of said monomer of structure II) is preferably at least 100 mol % and is, more preferably, greater than 100 mole %. It may be in the range 100 to 105 mol %.

The mol % of carbonates (which term is intended to encompass carbonate (CO₃²⁻) and bicarbonate (HCO₃⁻)) other than sodium carbonate and potassium carbonate used in the process is preferably less than 5 mol %, more preferably less than 1 mol % (again related to the moles of said monomer of structure II).

Preferably, the only carbonates used in the process are sodium carbonate and potassium carbonate.

In the process, alkali metal fluoride (which suitably comprises sodium fluoride and may comprise both sodium fluoride and potassium fluoride when sodium and potassium carbonate are used in the process, as is preferred) is suitably produced as a bi-product of the polycondensation. The ratio of the total number of moles of alkali metal fluoride produced in the process divided by the number of moles of repeat units of formula I is suitably in the range 0.9 to 1.1 and is preferably about 1.

In the process, carbon dioxide is suitably produced as a bi-product of the polycondensation. The ratio of the total number of moles of carbon dioxide produced in the process divided by the number of moles of repeat units of formula I is suitably in the range 0.9 to 1.1, and is preferably about 1

Said polymeric material having a repeat unit of formula I may include at least 90 mol %, suitably at least 95 mol %, preferably at least 98 mol %, especially at least 99 mol % of repeat units of formula I.

Said polymeric material having a repeat unit of formula I may include at least 90 wt %, suitably at least 95 wt %, preferably at least 98 wt % of repeat units of formula I.

Said polymeric material having a repeat unit of formula I preferably includes fluorine moieties at its ends. Preferably at least 90% (more preferably about 100%) of the number of end groups in said polymeric material comprise fluorine atoms.

In the process, the ratio of the number of moles of monomer of formula II divided by the total number of moles of monomers used in the process is preferably in the range 0.90 to 1, more preferably in the range 0.95 to 1, especially in the range 0.98 to 1. When said ratio is not equal to 1, the process may include introducing an additional monomer into the process. Said additional monomer preferably does not include an hydroxyl moiety. Said additional monomer preferably includes at least two halogen atoms, especially two fluorine atoms. Said additional monomer is preferably a difluoro-compound. It is preferably arranged to react with and replace the OH moieties of monomer of formula II. It is preferably arranged to end-cap the polymeric material formed in the process. As a result, ends of the polymeric material of formula I suitably include fluorine atoms which suitably help to stabilise the polymeric material.

In the process, it is preferred that no hydroxyl group-containing monomer is used other than said monomer of structure II. Said process preferably does not comprise use of a hydroquinone.

Said additional monomer preferably includes one or more phenyl moieties. Said additional monomer suitably includes at least one phenyl moiety, substituted in the 4-position, suitably with a fluorine atom. Said additional monomer may include two phenyl moieties. In this case, preferably both of said two phenyl moieties are substituted by fluorine atoms, suitably in the 4-positions. Said two phenyl moieties may be separated by a ketone moiety. Said additional monomer is preferably 4,4′-difluorobenzophenone.

Said process suitably include polycondensing 95 to 100 wt % (preferably 97.5 to 99.5 wt %) of said monomer of structure II in the presence of 0 to 5 wt % (preferably 0.5 to 2.5 wt %) of said additional monomer.

In a preferred embodiment, said process is carried out in the presence of a solvent (which is suitably a polar aprotic organic solvent). Advantageously, the ratio of the total number of moles of monomers used in the process divided by the total number of moles of solvent may be greater than 0.3, suitably greater than 0.4. The ratio may be in the range 0.1 to 0.8, for example in the range 0.3 to 0.6.

Said solvent may be of formula

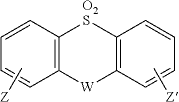

where W is a direct link, an oxygen atom or two hydrogen atoms (one attached to each benzene ring) and Z and Z′, which may be the same or different, are hydrogen atoms or phenyl groups. Examples of such aromatic sulphones include diphenylsulphone, dibenzothiophen dioxide, phenoxanthin dioxide and 4-phenylsulphonyl biphenyl. Diphenylsulphone is a preferred solvent.

The process is preferably carried out under substantially anhydrous conditions. In the process, the compound of formula II is suitably contacted with carbonate of the type described in the presence of said solvent, especially diphenylsulphone. Polymerisation is suitably effected at a temperature within the range 150° C. to 400° C. In the process, the reactants are suitably heated up to a maximum temperature which may be greater than 300° C., for example in the range 300° C. to 350° C. The process may be carried out without holding the temperature at any temperature less than 300° C. Heat up, to a temperature in excess of 300° C., may be substantially continuous.

Advantageously, preferably no blanket of inert gas (e.g. N₂) is introduced and/or used in the process, for example to minimise oxidation. The process may be carried out under ambient atmospheric conditions.

The process may be carried out in a receptacle and, advantageously, the receptacle may be run fuller than in prior art processes for production of said polymeric material because only half the amount of carbon dioxide is produced compared to prior art processes. In the process the maximum amount of liquid in the receptacle during the process may fill at least 80%, preferably at least 85% of the volume of the receptacle. Said volume may be less than 95%.

The polymeric material of the first aspect preferably has a Tm of less than 340° C. It may have a Tg in the range 142 to 144° C. Said polymeric material of the first aspect may include any of the preferred features described according to the second embodiment.

According to a second aspect of the invention, there is provided a polymeric material which comprises a repeat unit of formula I, wherein said polymeric material has a Tm of less than 340° C. and a Tg in the range 142 to 144° C.

Preferred features of the polymeric material of the first and second aspects are described below.

Preferably, the only repeat units in said polymeric material of formula I are repeat units which include phenyl moieties (especially unsubstituted phenyl moieties), ether moieties and ketone moieties. Preferably, the only repeat units in said polymeric material of formula I are repeat units which comprise unsubstituted phenyl moieties separated by ether or ketone moieties. In said repeat units, preferably the ratio of the number of ether moieties divided by the number of ketone moieties is 2; and the ratio of the sum of the number of ether moieties and ketone moieties divided by the number of phenyl moieties is 1.

Said polymeric material having a repeat unit of formula I may include at least 90 mol %, suitably at least 95 mol %, preferably at least 98 mol %, especially at least 99 mol % of repeat units of formula I.

Said polymeric material having a repeat unit of formula I may include at least 90 wt %, suitably at least 95 wt %, preferably at least 98 wt % of repeat units of formula I.

Said polymeric material having a repeat unit of formula I preferably includes fluorine moieties at its ends. Preferably at least 90% (more preferably at least 99%, especially about 100%) of the number of end groups in said polymeric material comprise fluorine atoms.

Said polymeric material may have a Tm (assessed as described hereinafter) of less than 339° C., suitably less than 338° C., preferably less than 337° C. The Tm may be in the range 332° C. to 339° C., suitably in the range 333° C. to 337° C.

The difference (Tm−Tg) between the Tm and Tg of said polymeric material may be in the range 189-195° C.

In a preferred embodiment, said polymeric material has a Tg in the range 142° C.-144° C., a Tm in the range 333° C. to 337° C. and the difference between the Tm and Tg is in the range 189° C. to 195° C.

Said polymeric material may have a crystallinity measured as described hereinafter of at least 25%. Crystallinity may be less than 38%.

Said polymeric material suitably has a melt viscosity (MV) of at least 0.06 kNsm⁻², preferably has a MV of at least 0.08 kNsm⁻², more preferably at least 0.085 kNsm⁻², especially at least 0.09 kNsm⁻². MV of said polymer material is suitably measured using capillary rheometry operating at 400° C. at a shear rate of 1000s⁻¹ using a tungsten carbide die, 0.5 mm×3.175 mm. Said polymer material may have a MV of less than 1.00 kNsm⁻², suitably less than 0.8 kNsm⁻².

Said polymeric material may have a tensile strength, measured in accordance with ISO527 of at least 40 MPa, preferably at least 60 MPa, more preferably at least 80 MPa. The tensile strength is preferably in the range 80-110 MPa, more preferably in the range 80-100 MPa.

Said polymeric material may have a flexural strength, measured in accordance with ISO178 of at least 130 MPa. The flexural strength is preferably in the range 135-180 MPa, more preferably in the range 140-150 MPa.

Said polymeric material may have a flexural modulus, measured in accordance with ISO178 of at least 2 GPa, preferably at least 3GPa. The flexural modulus is preferably in the range 3.0-4.5 GPa, more preferably in the range 3.0-4.0 GPa.

Said polymeric material may be in the form of pellets or granules, wherein the pellets or granules include at least 95wt %, preferably at least 99wt %, especially about 100 wt % of said polymeric material. Pellets or granules may have a maximum dimension of less than 10 mm, preferably less than 7.5 mm, more preferably less than 5.0 mm.

Said polymeric material suitably has L*, assessed as described hereinafter, of at least 65, preferably at least 66, more preferably at least 67. The L* may be less than 78. In some embodiments, it may be less than 75. L* is suitably in the range 66 to 782.

According to a third aspect of the invention, there is provided a pack comprising a polymeric material as described herein.

Said pack may include at least 1 kg, suitably at least 5 kg, preferably at least 10 kg, more preferably at least 14 kg of material of which at least a part is made up of said polymeric material. Said pack may include 1000 kg or less, preferably 500 kg or less of said material. Preferred packs include 10 to 500 kg of said material.

Said pack may include at least 1 kg, suitably at least 5 kg, preferably at least 10 kg, more preferably at least 14 kg of a said polymeric material. Said pack may include 1000 kg or less, preferably 500 kg or less of said polymeric material. Preferred packs include 10 to 500 kg of a said polymeric material.

Polymeric material in said pack may be in powder or granular form.

Said pack may comprise packaging material (which is intended to be discarded or re-used) and a desired material (which suitably comprises said polymeric material). Said packaging material preferably substantially fully encloses said desired material. Said packaging material may comprise a first receptacle, for example a flexible receptacle such as a plastics bag in which said desired material is arranged. The first receptacle may be contained within a second receptacle for example in a box such as a cardboard box.

Any feature of any aspect of any invention or embodiment described herein may be combined with any feature of any aspect of any other invention or embodiment described herein mutatis mutandis.

Specific embodiments of the invention will now be described, by way of example, with reference to the accompanying figures, in which:

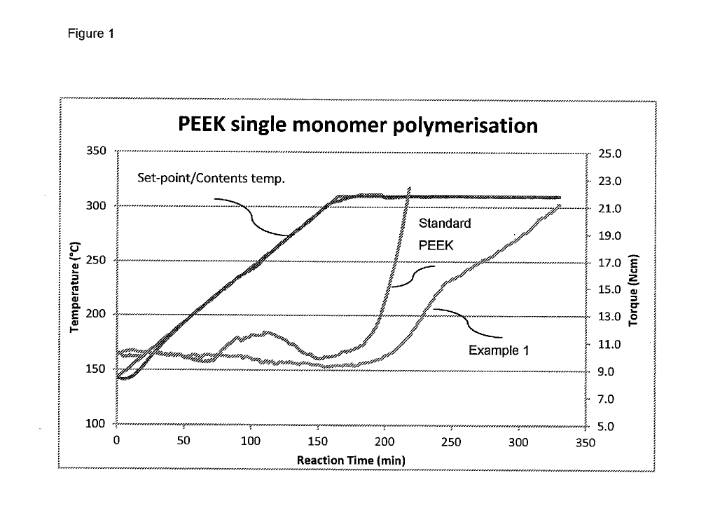

FIG. 1 is a polymerisation profile of a process for producing PEEK from a single monomer and an equivalent profile for a standard process for producing PEEK; and

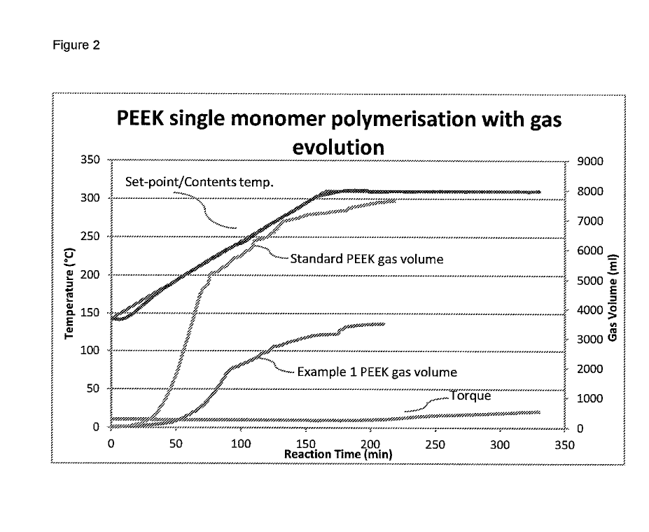

FIG. 2 illustrates gas evolution during the process for producing PEEK from a single monomer and the equivalent gas evolution from a standard process for producing PEEK.

The following materials are referred to hereinafter:

4-fluoro-4′-(4-hydroxyphenoxy) benzophenone synthesised as described in Example 4, referred to as “FHPB”.

In general terms the preparation of polyetheretherketone (PEEK) may be undertaken by polycondensation of a single monomer (4-fluoro-4′-(4-hydroxyphenoxy) benzophenone) in diphenylsulphone (DPS) solvent and in the presence of sodium carbonate and potassium carbonate as summarized in the scheme below.

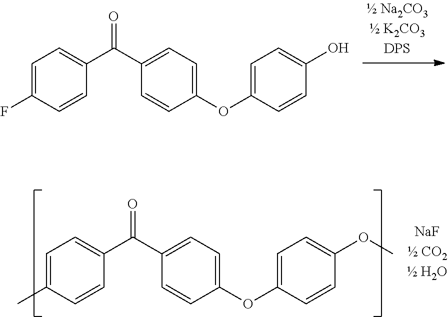

A small amount of 4,4′-difluorobenzophenone (BDF) may be included in the polymerisation mixture (or may be added during the polymerisation) to control the rate of polymerisation, act as an end stopper and/or to ensure the PEEK polymer is fluorine ended.

Compared to the process described in EP1879 which involves polycondensation of BDF and hydroquinone (HQ), use of the single monomer may be advantageous for at least the following reasons:
(a) The single monomer process only requires half as much carbonate to effect the reaction, meaning that only half as much sodium fluoride (which needs to be removed in subsequent processing) is formed.
(b) In the process of EP1879, molecular weight of the PEEK is controlled by precise control of the ratio of BDF to HQ used. This can be difficult, particularly on an industrial scale, meaning that molecular weight control can be difficult. There is no monomer ratio to control in the single monomer process.
(c) In the process of EP1879, the BDF and HQ monomers need to be of very high purity in order to produce high quality PEEK polymer and small changes in monomer purity can have dramatic effects on resultant polymer properties. Purity is less critical with the single monomer process.
(d) In the process of EP1879, the BDF and HQ are susceptible to being lost from the reaction mixture by sublimation at elevated temperatures, meaning that precise control of the BDF:HQ ratio can be difficult. This is not an issue with use of a single monomer which is less susceptible to sublimation in any event.
(e) In the process of EP1879, equimolar amounts of carbonates (based on the moles of HQ) are required and two equivalents of carbon dioxide are produced for every PEEK unit. Holds are introduced into the process to control gas evolution but there is still a risk of foaming meaning that polymerisation vessels are run with a significant head space (as much as 30% headspace). Both of these lead to reduced plant efficiency. Advantageously, the single monomer process produces half as much carbon dioxide and, therefore, efficiency may be significantly improved.
(f) In the process of EP1879, the necessary holds in the process lead to production of greater levels of oligomeric material which tends to crystallise in the polymerisation vessel resulting in poor heat transfer and, consequently, extended reaction times. Because of this there is a limit on how concentrated the polymerisation reaction can be run. Advantageously, the single monomer process may be run without holds. In addition, use of higher concentration means that more polymer can be made per batch, increasing plant capacity.
(g) The single monomer process produces lighter-coloured polymer compared to that produced using the process of EP1879.

Further details on the process are provided below.

### EXAMPLE 1

### General Method for Preparing PEEK Using Single Monomer

DPS (132.0 g, 0.616 mol), FHPB (92.49 g, 0.300 mol) and BDF (0.87 g, 0.004 mol) were charged to a 500 ml flange flask equipped with an anchor type agitator, overhead stirrer, gas inlet and air condenser. After inerting with nitrogen, (a step which is not required but which was included so as to be comparative with Example 3), the mixture was heated to 160° C. with stirring at 70 rpm. Sodium carbonate (15.98 g, 0.151 mol) and potassium carbonate (0.42 g, 0.003 mol) was slowly added and the resulting mixture heated at 1° C./min to 310° C. The polymerisation mixture was maintained at 310° C. until the desired torque rise was reached. At this point the molten toffee was poured into a foil tray, allowed to cool, milled and washed with 2 litres of acetone and then with warm water at a temperature of 40-50° C. until the conductivity of the waste water was <2 μS. The resulting polymer powder was dried in an air oven for 12 hours at 120° C.

### EXAMPLE 2 (COMPARATIVE EXAMPLE)

### General Method for Preparing PEEK Using Sodium Salt of Single Monomer

In this comparative example, PEEK was prepared using the sodium salt of FHPB as illustrated in the scheme below.

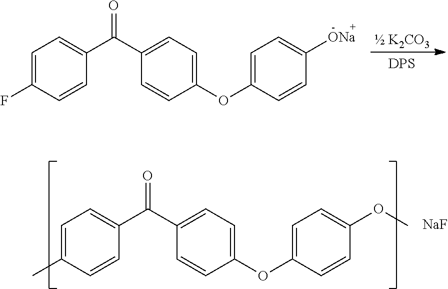

FHPB was reacted with an equimolar amount of sodium hydroxide to produce the sodium salt which could then be polymerised in DPS without any further sodium carbonate.

In the process, DPS (132.0 g, 0.616 mol) was charged to a 500 ml flange flask equipped with an anchor type agitator, overhead stirrer, gas inlet and air condenser. After inerting with nitrogen the mixture was heated to 290° C. with stirring at 70 rpm. The FHPB sodium salt (99.08 g, 0.300 mol) was added over 10 minutes whilst maintaining the contents temperature at 290-300° C. When the addition was complete potassium carbonate (0.42 g, 0.003 mol) and BDF (0.87 g, 0.004 mol) were added. The resulting mixture was heated to 310° C. and maintained at this temperature until the desired torque rise was reached. If required, further potassium carbonate (0.21 g, 0.002 moles) was added to increase the rate of polymerisation. At this point the molten toffee was poured into a foil tray, allowed to cool, milled and washed with 2 litres of acetone and then with warm water at a temperature of 40-50° C. until the conductivity of the waste water was <2 μS. The resulting polymer powder was dried in an air oven for 12 hours at 120° C.

### EXAMPLE 3 (COMPARATIVE EXAMPLE)

### General Method for Preparing PEEK Using BDF and HQ as Described in EP1879

DPS (132.0 g, 0.616 mol), HQ (33.03 g, 0.300 mol) and BDF (66.33 g, 0.304 mol) were charged to a 500 ml flange flask equipped with an anchor type agitator, overhead stirrer, gas inlet and air condenser. After inerting with nitrogen the mixture was heated to 160° C. with stirring at 70 rpm. When the mixture was molten, sodium carbonate (31.96 g, 0.302 mol) and potassium carbonate (0.83 g, 0.006 mol) was slowly added and the resulting mixture heated at 1° C./min to 310° C. The polymerisation mixture was maintained at 310° C. until the desired torque rise was reached. The reaction mixture was then poured into a foil tray, allowed to cool, milled and washed with 2 litres of acetone and then with warm water at a temperature of 60-70° C. until the conductivity of the waste water was <2 μS. The resulting polymer powder was dried in an air oven at 120° C.

### EXAMPLE 4

### Synthesis of 4-fluoro-4′-(4-hydroxyphenoxy) benzophenone monomer (FHPB)

Aluminium chloride (333.35 g, 2.5 mol) and 1,2-dichlorobenzene (650 ml) and were charged to a nitrogen inerted 1 L jacketed reactor flask equipped with anchor style agitator, overhead stirrer, temperature probe, addition funnel and a condenser with an outlet to a caustic scrubber.

The reaction was heated to 60° C. and 4-phenoxyphenol (186.21 g, 1.0 mol) was added portion wise. When the addition was complete 4-fluorobenzoylchloride (158.56 g, (1.0 mol) was added drop-wise over 120 minutes. The reaction mixture was heated at 1° C./min to 90° C. and maintained at this temperature for 60 minutes.

The brown coloured solution was then carefully quenched onto stirred cold water and the biphasic mixture was allowed to exotherm to 90° C. in order to solubilise the monomer in the organic phase. The aqueous phase was removed and the organic phase washed with demineralised water (3×500ml) to remove aluminium salts and excess acidity.

The organic phase was cooled at 1 ° C./min to 0° C. and the crystalline solid filtered off and washed with 60/80 petroleum ether (400 ml).

The crude product was dissolved in hot toluene (5 ml per 1 g of product), stirred with activated carbon (2% w/w) and then hot filtered to remove the carbon. The clear yellow filtrate was slowly cooled to 0° C., filtered, washed with toluene (200 ml), 60/80 petroleum ether (400 ml) and dried under vacuum at 60° C. The product was 99.98% pure and had a melting point of 142.3° C.

Assessments and results for Examples 1, 2 and 3 are detailed and discussed below. Note that references to “standard PEEK” and “standard PEEK process” refer to PEEK made as described in Example 3.
1. Referring to FIG. 1, the set point temperature and contents temperature substantially overlie one another. More importantly, it will be noted that the torque for the Example 1 process increases steadily once the polymerisation temperature has been reached with no increase in torque during the heat up to the polymerisation temperature. However, for the standard PEEK process, the molecular weight of the polymer increases rapidly and is difficult to control once the polymerisation temperature is reached. Also, the rise and decrease in torque during heat-up, illustrates that oligomers formed in the reaction have come out of solution. Such a crystallised material can detrimentally affect the properties of the PEEK produced. This is in contrast to the torque rise for the standard PEEK process which illustrates the greater difficulty in controlling this process.
2. The gas evolution of the Example 1 process was studied and compared with the standard PEEK process. In the Example 1 process significant gas evolution began to occur when the temperature of the contents reached 200° C. as opposed to 180° C. for the standard PEEK process. For the Example 1 process only half the amount of gas was evolved and at lower peak flow rates than for the standard PEEK process.
3. The process of Example 1 was used to produce PEEK of relatively high MV (e.g. MV=0.56 KNsm⁻² and 0.57 KNsm⁻² where MV is measured at 400° C. using a tungsten carbide die of dimensions 0.5 mm×3.175 mm at a shear rate of 1000 s⁻¹.
4. A DSC analysis was undertaken on polymers made as described in Example 1. A DSC method has been used to evaluate the crystallinity and other characteristics of polymers of Example 1 using a Mettler Toledo DSC1 Star system with FRS5 sensor.
The Glass Transition Temperature (Tg),crystallisation temperature (Tc) and the Melting Temperature (Tm) were determined using the following DSC method.
A dried sample of each polymer was compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg plus or minus 3 mg sample of each film was scanned by DSC as follows:
Step 1 Perform and record a preliminary thermal cycle by heating the sample from 30° C. to 400° C. at 20° C. /min.
Step 2 Hold for 5 minutes.
Step 3 Cool at 20° C./min to 30° C. and hold for 5 mins.
Step 4 Re-heat from 30° C. to 400° C. at 20° C./min, recording the Tg, Tc and Tm,
From the DSC trace resulting from the scan in step 4, the onset of the Tg was obtained as the intersection of the lines drawn along the pre-transition baseline and a line drawn along the greatest slope obtained during the transition. The Tm was the temperature at which the main peak of the melting endotherm reaches a maximum. Tc is measured as the maximum point of the crystallisation peak on the 2^{nd} heat/cool cycle. The polymer was subjected to three repeat cycles, to provide an indication of the thermal stability and quality of the polymer. Cycle 1 also ensures any thermal history in the polymer has been erased. Generally, values quoted for Tm etc. are those taken from Cycle 2.

The Heat of Fusion for melting (ΔHm) was obtained by connecting the two points at which the melting endotherm deviates from the relatively straight baseline. The integrated area under the endotherm as a function of time yields the enthalpy (mJ) of the melting transition: the mass normalised heat of fusion is calculated by dividing the enthalpy by the mass of the specimen (J/g). The level of crystallisation (%) is determined by dividing the Heat of Fusion of the specimen by the Heat of Fusion of a totally crystalline polymer, which for polyetheretherketone is 130 J/g.

Results for polymers produced (referred to as Examples 1a, 1b and 1c) made as described in Example 1 are provided in Table 1.

TABLE 1

| | Cycle 1 | | Cycle 2 | | | | Cycle 3 | |
|---|---|---|---|---|---|---|---|---|
| Example | Tₘ (° C.) | T_{c} (° C.) | T_{g} (° C.) | Tₘ (° C.) | T_{c} (° C.) | X (%) | Tₘ (° C.) | T_{c} (° C.) |
| 1a) | 335.5 | 265.7 | 143.8 | 335.5 | 265.1 | 29.8 | 335.6 | 264.8 |
| 1b) | 335.1 | 283.9 | 143.8 | 336.0 | 283.1 | 27.6 | 335.7 | 282.6 |
| 1c) | 334.2 | 277.2 | 144.2 | 334.5 | 265.3 | 27.0 | 334.3 | 262.8 |

The peak melting point value for commercially available PEEK made using a standard PEEK process is approximately 340° C. Thus, the Example 1 process leads, advantageously, to a lower Tm (of approximately 335° C.).
5. Measurement of PEEK colour is made on a thin crystalline film by a Minolta Chromameter CR400.
PEEK powder (made as described in Examples 1 and 3 with different MVs) is melted and pressed at 400° C. and 5 tonnes within a 12 cm×12 cm aluminium foil frame, which itself is between two aluminium foil plates, and cooled to 150° C. for 10 minutes. This produces a crystalline film of 0.25-0.30 mm thickness.
The Chromameter CR400 is pressed onto the film and the trigger pressed so that an L*a*b* colour measurement is made. This process is repeated on a different part of the film. The difference is L* values must be 1.6 for a reliable result. An average of the two readings is taken to generate the L* value.
Results of colour measurements are provided below

| Example No. | MV (KNsm⁻²) | L* |
|---|---|---|
| 1a | 0.37 | 70.66 |
| 1b | 0.56 | 67.94 |
| 1c | 0.57 | 70.61 |
| 3a | 0.66 | 63.07 |
| 3b | 0.58 | 61.25 |
| 3c | 0.51 | 59.68 |

The above table confirms that the process of Example 1 produces lighter (i.e. higher L*) compared to the standard PEEK process of Example 3. The process of Example 2 was found to produce relatively dark polymers which, on the basis of a simple visual assessment, clearly had lower L* than both Example 1 and Example 3 polymers.
6. A Jasco V-630 dual beam spectrophotomer was used to measure absorbance with 1 cm path length glass cells. Concentrated Sulphuric acid (density 1.84 g/cm⁻³) was charged to both the reference and sample cells and the machine zeroed. The sample cell was then charged with a solution of respective polymers in sulphuric acid (1% w/v solution). The UV spectrum was recorded from 600 to 500 nm and the absorbance at 550 nm was measured.

| | Absorbance |
|---|---|
| Example | (550 nm) |
| 1a | 0.1710 |
| 1b | 0.2230 |
| 1c | 0.0771 |

The relatively low absorbance of the polymer illustrates that it has low chain branching and is a high quality polymer.
Thus, it should now be appreciated that the process of Example 1 can be used to produce high quality, relatively light coloured polymers having a lower Tm than those produced using a standard PEEK process. Furthermore, the process of Example 1 is advantageous over the standard PEEK process for reasons given herein.
The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A process for producing a polymeric material having a repeat unit of formula I 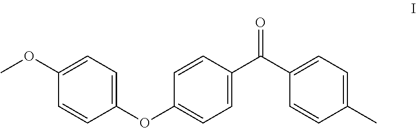
the process comprising polycondensing a monomer of formula II

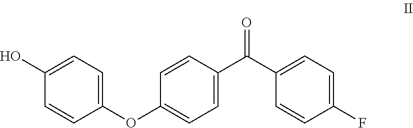 [SMILES: O=C(c1ccc(F)cc1)c1ccc(Oc2ccc(O)cc2)cc1]

2. The process according to claim 1, wherein said process is carried out in the presence of alkali metal carbonate.

3. The process according to claim 1, wherein the ratio of the total number of moles of alkali metal fluoride produced in the process divided by the number of moles of repeat units of formula I is in the range 0.9 to 1.1 or wherein the ratio of the total number of moles of carbon dioxide produced in the process divided by the number of moles of repeat units of formula I is in the range 0.9 to 1.1.

4. (canceled)

5. The process according to claim 1, wherein said polymeric material includes at least 90 mol % of repeat units of formula I.

6. The process according to claim 1, wherein said polymeric material includes fluorine moieties at its ends.

7. The process according to claim 1, wherein, in the process, the ratio of the number of moles of monomer of formula II divided by the total number of moles of monomers used in the process is in the range 0.90 to 1.

8. The process according to claim 1, wherein the process includes introducing an additional monomer into the process, wherein said additional monomer does not include an hydroxyl moiety and includes at least two fluorine atoms and optionally includes at least one phenyl moiety, substituted in the 4-position, with a fluorine atom.

9. (canceled)

10. The process according to claim 8, wherein said additional monomer is 4,4′ difluorobenzophenone.

11. The process according to claim 8, wherein said process includes polycondensing 95 to 100 wt % of said monomer of formula II in the presence of 0 to 5 wt % of said additional monomer.

12. The process according to claim 1, wherein said process is carried out in the presence of a solvent of the following formula 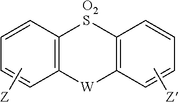
wherein W is a direct link, an oxygen atom or two hydrogen atoms and Z and Z′, are the same or different and, are hydrogen atoms or phenyl groups.

13. The process according to claim 1, wherein the process is carried out without holding the temperature at any temperature less than 300° C.

14. The process according to claim 1, wherein no blanket of inert gas is introduced and/or used in the process or wherein the process is carried out under ambient atmospheric conditions.

15. (canceled)

16. The process according to claim 1, wherein the process is carried out in a receptacle and the maximum amount of liquid in the receptacle during the process fills at least 80% of the volume of the receptacle.

17. A polymeric material which comprises a repeat unit of formula I 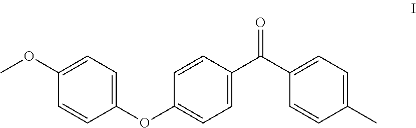
wherein said polymeric material has a Tm of less than 340° C. and a Tg in the range 142 to 144° C.

18. The polymeric material according to claim 17, wherein the only repeat units in said polymeric material of formula I are repeat units which include phenyl moieties, ether moieties or ketone moieties or wherein said polymeric material includes at least 95 mol % of repeat units of formula I.

19. (canceled)

20. The polymer material according to claim 17, wherein said polymeric material includes fluorine moieties at its ends.

21. The polymeric material according to claim 17, wherein said polymeric material has a Tm of less than 339° C. or wherein said polymeric material has a Tg in the range 142° C.-144° C., a Tm in the range 333° C. to 337° C. and the difference between the Tm and Tg is in the range 189° C. to 195° C.

22. (canceled)

23. The polymeric material according to claim 17, wherein said polymeric material has a crystallinity of at least 25%.

24. The polymeric material according to claim 17, wherein said polymeric material has a melt viscosity (MV) in the range 0.06 kNsm⁻² to 1.00 kNsm⁻² or wherein said polymeric material has L* of at least 65.

25. (canceled)

26. A pack comprising a polymeric material according to claim 17.
